(19) United States
(12) Patent Application Publication
(10) Pub. No.: US 2011/0057033 A1
(43) Pub. Date: Mar. 10, 2011

(54) Method for Storing, Delivering, and Receiving Secure Background-Investigation Information

(75) Inventor: Paul Possanza, Lake Worth, FL (US)

(73) Assignee: Carol J. Possanza, Boca Raton, FL (US)

(21) Appl. No.: 12/556,861

(22) Filed: Sep. 10, 2009

(51) Int. Cl. G06K 5/00; G06F 12/14; G06Q 99/00

(52) U.S. Cl. 235/382; 726/28; 705/1.1

(57) ABSTRACT

A method for storing, delivering, and receiving background information includes receiving, by a subject, a request for background information from a requesting party. The subject then requests performance of a background information inquiry from a searching party and subsequently receives a background information inquiry result from the searching party. The background information inquiry result is stored on a tangible medium that has at least one mechanism for preventing editing of the background information inquiry result by the subject. The subject then presents the tangible medium to the requesting party, the requesting party knowing that the information has not been tampered with.

### FIELD OF THE INVENTION

The present invention relates generally to background investigations, and more particularly relates to a secure device and method for storing, carrying, and presenting background information to interested third parties with assurance that the information has not been altered by the presenter.

### BACKGROUND OF THE INVENTION

A “background” investigation attempts to locate information about a person's past that may be relevant to a third person. Although these investigations were originally performed only in situations where the subject was seeking a position that required high security or a position of trust like employment in a school, hospital, bank, airport, law enforcement, or other similar positions, they are commonplace today. These checks are important because they allow better informed and less-subjective evaluations to be made about a person. Examples of relevant background information are employment history, criminal history, educational verification, driving records, credit history, litigation history, sex offender registry entries, credential verification, reference checks, credit reports, Patriot Act searches, medical, mental, and physiological evaluations and records, and many more.

Background checks were traditionally performed by the police but are now most often purchased as a service from a private business. In the employment context, the potential employer typically commissions the search from a third party, who searches one or more data bases for information that may be of interest to the potential employer. Exemplary databases include state and federal criminal records, credit records, previous employment history records, residential records, and many others. However, thorough background searches require a searcher's time conducting the search and often involve subscription fees for access to the databases searched. In addition, there is also the fee of printing, mailing, and maintaining the report. This cost is usually born by the employer who, if considering multiple candidates, will end up shouldering a substantial cost, with no guarantee that a suitable candidate will be located.

Continuing with the employment example, when a candidate applies at multiple work locations, their background might be checked multiple times in a short period of time. This results in redundant work, expense, and information. It can also be detrimental to the candidate's credit history, as some credit-scoring systems reduce a credit score each time it is checked. These detriments are due to the fact that potential employers do not share information. In fact, candidates applying at competing companies are usually careful not let the companies know of each other, which therefore obviates their ability to share information with each other.

In some circumstances, the employer, or other person requesting a background check be conducted, might request that the subject of the check bear the cost of the check. In this case, a candidate applying at multiple employers would have to bear the cost of multiple searches, possibly at a time when he or she can least afford it.

In addition, to perform a proper investigation, the subject of the search necessarily must provide confidential information, such as his/her social security number, home address, previous address, previous employers, etc. Providing this information to multiple parties, for instance, introduces risks to the search subject, such as identity theft. This also places liability onto the parties receiving the information and requires them to maintain the information as confidential. Furthermore, the search may be performed more extensively than the scope agreed to by the subject, leading to a violation of privacy. The subject may never even know what information was uncovered.

The possibility exists that the candidate will be provided with a copy of the report that he or she could present to multiple employers. However, the requesting employer cannot be guaranteed that the subject has not tampered with or altered the report and, thus, the reliability of the information is suspect, which frustrates the purpose of presenting the information.

Therefore a need exists to overcome the problems with the prior art as discussed above.

### SUMMARY OF THE INVENTION

Briefly, in accordance with the present invention, disclosed is a method for providing secure personal information including the steps of receiving a request for personal information pertaining to a subject's background, conducting a personal information inquiry pertaining to the subject, deriving a personal information inquiry result, electronically storing at least a portion of the inquiry result on a tangible medium, the inquiry result readable by a third party, such as a potential employer, protecting the inquiry result with at least one mechanism for preventing unauthorized editing by the subject, and providing custody of the tangible medium to the subject.

In accordance with a further feature of the present invention, the mechanism includes rendering the inquiry result physically or informationally, i.e. electronically, corrupt in an event of editing by the subject and rendering the inquiry result corrupt in an event of inquiry result access by the subject.

In accordance with a further feature of the present invention, the tangible medium is a smart card.

In accordance with yet another feature of the present invention, the stored inquiry result is encrypted.

In accordance with one more feature of the present invention, the stored inquiry result is valid only for a finite amount of time.

In accordance with another feature, an embodiment of the present invention includes a method for providing background information to a requesting party, where the method includes receiving, by a subject, a request for background information from a requesting party, requesting performance of a background information inquiry from a searching party, receiving from the searching party a tangible medium electronically storing a background information inquiry result and having at least one mechanism for preventing at least one of editing, copying, and replacement of the background information inquiry result by the subject, and presenting the tangible medium to the requesting party.

In accordance with yet another feature, an embodiment of the present invention includes a method for receiving background information, where the method includes the steps of receiving a request for placement of a subject in a position of trust, requesting from the subject information pertaining to the subject's background, and receiving from the subject a tangible medium having at least one piece of background information pertaining to the subject stored thereon and having at least one mechanism for preventing editing, copying, and replacement of the background information by the subject.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a process flow diagram of a method for providing secure reliable background information to a recipient in accordance with the present invention.

FIG. 2 is a process flow diagram of a method for requesting and receiving secure reliable background information from a background search subject in accordance with an embodiment of the present invention.

FIG. 3 is a diagram illustrating a front face of one embodiment of a medium capable of storing and communicating background information and a device capable of reading the information in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The present invention, according to an embodiment, overcomes problems with the prior art by providing a method for delivering reliable background information to an interested party. Advantageously, the subject of the background check is able to provide to the interested party, a tangible medium securely and reliably storing the background information. “Tangible,” as used herein, indicates the ability to be held and perceived by the sense of touch and “medium,” as used herein, indicates something on which information may be stored. The medium is secure, in that the subject is not able to edit the information and, in some embodiments of the present invention, any attempted editing is detectable and identifiable by the interested party. Because the subject is unable to edit the information, the receiving party can be ensured that the information is in the form created by the background-checking entity. Advantageously, the secure medium allows information generated in a single background check to be presented to multiple interested parties, for instance, potential employers during a job search. In addition, since it is the subject of the search requesting the search and presenting the results, major problems of prior-art searches, such as identity theft, and violation of privacy, are avoided by the present invention.

Described now is an exemplary method and hardware platform for use with embodiments of the present invention.

A “background check” or “background investigation,” as used herein, refers to a process of searching public records, commercial records, financial records, and others, to compile information pertaining to a person (the subject). The amount of information included on a background check depends to a large degree on the sensitivity of the reason for which it is conducted—e.g., someone seeking employment at a minimum wage job would be subject to far fewer requirements than someone applying to work for the FBI.

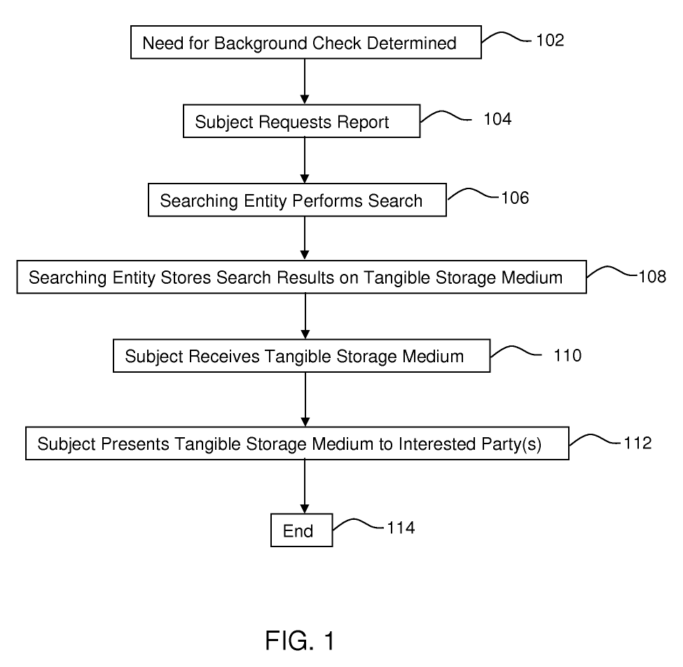

Referring now to the process flow diagram of FIG. 1, exemplary steps for performing the presently invention method are described. In step 102, a subject determines a need to obtain a background investigation and corresponding report. The need can arise from many sources, such as a request from a potential employer, or from the subject himself, for instance, by anticipating a future request for such a report. In step 104, the subject requests the report from a searching entity who, in step 106, performs the search and generates search results. The results can be extensive or basic, depending on the need or the amount of searching that is being paid for by the subject. For purposes of the present invention, the search results include at least one fact pertaining to the subject of the search.

In step 108, the searching entity stores the search results or at least a portion of the search results on tangible data storage medium, such as a compact disc (CD), digital video disc (DVD), memory card, a smart card, a microfiche, secure paper, or any other medium capable of storing data. The data is, however, according to embodiments of the present invention, stored on the medium in a secure manner, so that the data cannot be altered by the subject. In the alternative, the data is stored so that any successful and/or attempted altering of the data is detectable by the intended viewer of the data. For at least this reason, the medium has at least one mechanism for preventing editing, copying, and/or replacement of the background information by the subject. Examples of these mechanisms include encryption, which is the process of transforming data by using an algorithm (called cipher) to make it unreadable to anyone except those possessing special knowledge, usually referred to as a “key.” The word encryption also implicitly refers to the reverse process, decryption (e.g. “software for encryption” can typically also perform decryption), to make the encrypted information readable again (i.e. to make it unencrypted). The mechanism can also include digital rights management (DRM), which has become a generic term that refers to access control technologies used by hardware manufacturers, publishers, copyright holders, and others to limit usage of digital media or devices. The term, as used herein, refers to any technology that renders the unauthorized use, copying, or editing of media or devices technically formidable. Encryption is also used in digital rights management to prevent unauthorized use or reproduction of copyrighted material and also in software to protect against reverse engineering. The mechanism for preventing editing, copying, and/or replacement of the background information by the subject may be a physical aspect of the medium itself, which cannot be reproduced by the subject of the search, ensuring that no complete copy can be accomplished. For instance, a document or compact disc is easily reproduced, where a smart card or memory card is not.

In step 110, the subject receives the storage medium from the searching entity. Again, the medium has at least one mechanism that prevents the subject from accessing and/or editing the information on the medium. In some circumstances, the subject is able to access the data to confirm that it is accurate and of the type that should be presented to a third party. This can be advantageous, as the subject is not presenting false or disparaging information that is against the subject's interest. For example, it is not uncommon for a credit report to contain erroneous information. By allowing the subject to view the information, but not edit it, the subject can take corrective steps to remove the error. As another example, the search scope may have been merely for previous job history, but the searcher mistakenly extended the search to include criminal history. The opportunity to preview the data prior to presenting it to a third party provides an advantageous layer of error checking, which is not available in prior-art searches, where an employer, for instance, orders the search and reviews it before or at the same time as the subject. If a potential employer sees negative information, even if it is declared erroneous by the subject, the potential employer may not provide the subject with an opportunity to correct the mistake.

The subject is then able to present the storage medium, in a subsequent step 112, to one or more interested parties in an effort to convey background information pertaining to the subject to the one or more interested parties. The process ends at step 114.

Advantageously, and as should now be clear, the subject, when requesting the report from the searching entity (in step 104 in this example), is only required to provide private information to that single searching entity. Additionally, the subject, when ordering the search is able to specifically define the depth or extent of the search. The prior art requires the subject to provide sensitive information to one or multiple entities and consent to a search that may later exceed what the subject intended his or her consent to cover. The present invention, therefore, reduces the opportunity for identity theft and exposure of information that is not intended to be conveyed.

Furthermore, some embodiments of the present invention provide the completed background report on a medium that is readable by the subject or provides a copy of the data to the subject. Advantageously, the subject, unlike the prior art where the employer, for instance, receives the report directly, is able to review the results before providing them to the employer or other interested party. This opportunity to review the data provides the subject with the ability to correct mistakes prior to the employer seeing them, avoid embarrassment, avoid wasting his or her time, and avoid wasting the time of the interested party.

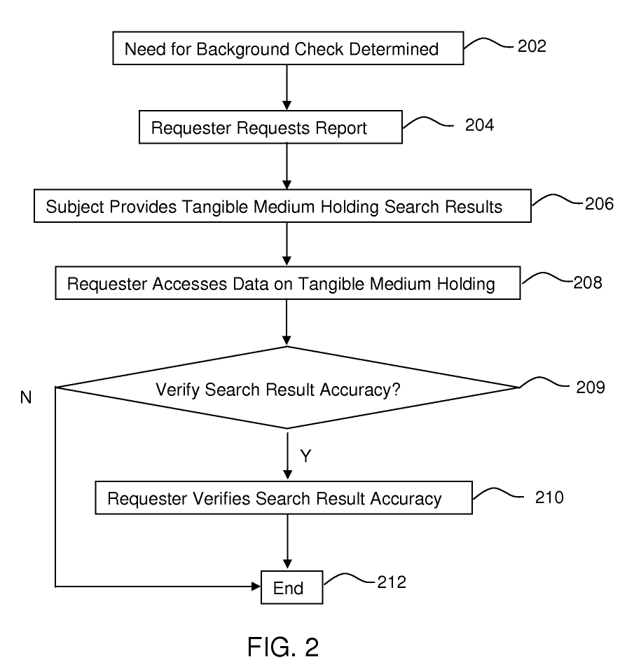

FIG. 2 shows the process flow of the present invention from the point of view of an interested party who, in this particular example, is a potential employer. In step 202, an employer determines an interest in the background of a subject. A specific example of this step would be an employer conducting an interview with an applicant and developing an interest in hiring the applicant. In step 204, the employer requests that the subject provide the employer with a reliable report of the subject's background. The subject then, in step 206, provides the employer with a tangible medium storing the report information. This step can be at the time of the interview, if the subject already has the report, or can be at a later time, after the report is requested and finalized. In step 208, the employer accesses the report through any means appropriate for accessing the information on the medium. The means can include a standard computer, specialized computer capable of reading computer-readable data contained by media, other media reading devices, proprietary devices, decryption devices or software, telephone, internet, special lighting, chemicals applied to the medium to cause characters to appear, magnetic reading, and more.

In an alternative step, 210, the employer verifies that the information has not been edited by the subject or any other party. This verification can be through use of software, hardware, a call to the searching entity, a verification through the internet, by mail, or any other feasible method of verifying information. The process ends at step 212.

Advantageously, the employer (or other type of interested party) has now received a reliable report of the subject's background. The report was provided without cost to the potential employer and is reliable, as the employer has been give assurances of accuracy through the one or more mechanisms used to protect the data and/or through a secondary verification.

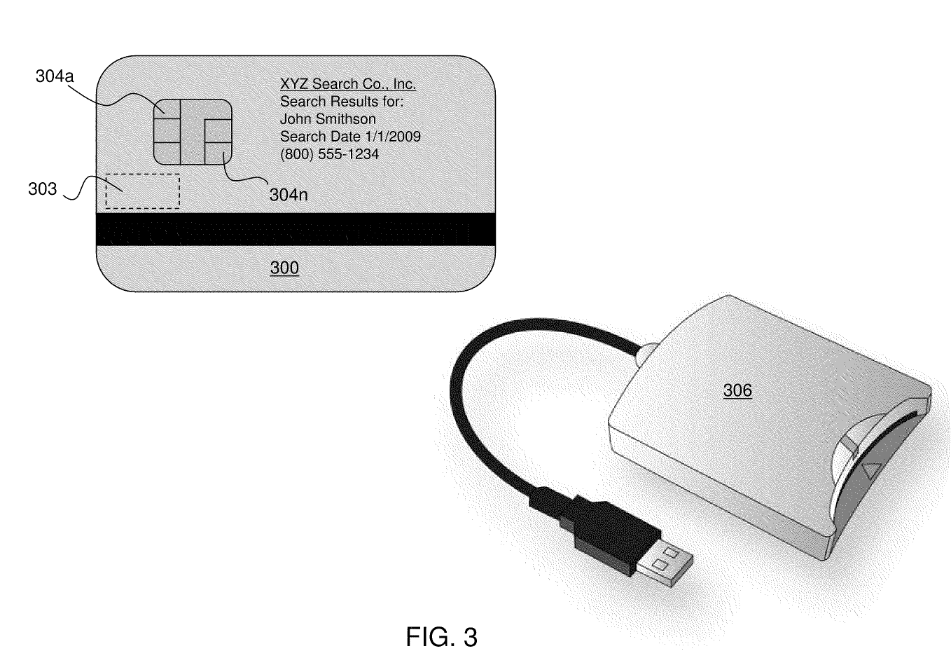

In one embodiment of the present invention, shown in FIG. 3, the medium used to store the data is a smart card 300, sometimes referred to as a chip card or integrated circuit card (ICC). A smart card is any pocket-sized card, e.g. credit-card size, with embedded integrated circuits 303 that can process and store data. The term “process data,” as used herein, means that it can receive and process an input—by way of the ICC applications—and deliver an output. There are two broad categories of ICCs: Memory cards that contain only non-volatile memory storage components and perhaps some specific security logic; and microprocessor cards that contain volatile memory and microprocessor components. To facilitate communication, many smart cards have a contact area 302 that is about 1 cm square and includes several gold-plated contact pads 304a-n. Smart cards or similar devices are well suited for the present invention. Unlike compact disks, for instance, which can be easily replicated, smart cards are capable of having circuitry or other mechanisms that render them uniquely identifiable and not reproducible by those other than the original manufacturer.

In one embodiment, the receiver of the card, e.g. employer, is provided with an authentication number or a key. This key can be transmitted (e.g. email, U.S. postage, etc.) to the employer by the card-making entity. The receiver (employer) can enter—manually or otherwise—the authentication number/key and the smart card 300 will output the stored data after verifying that the number belongs to an authorized viewer. This key provides an added layer of authenticity, as the employee will not be able to access the data at all before presenting it to the receiver.

In other embodiments, the intended viewer of the data is provided with a card reader 306 that authenticates itself or other system components, e.g. connected computer/software, to the card 300. When inserted into the reader 306, the contact area 302 makes contact with electrical connectors within the reader that can read information from the chip and write information back. Therefore, the data can be placed on the card 300 at the searcher location and then retrieved from the card 300 at the recipient location. The machine can be commercially available or proprietary so that the subject does not have readily available access to it.lnposelstartlnposelendlnposelstartlnposelend

According to another embodiment of the present invention, the card-making entity can “lock” the card, by either software or hardware, so that no further card storage is allowed to occur. In this manner, after the data is stored and the card is locked, the subject of the search, who is entrusted with custody of the physical card, cannot edit the information. In this embodiment, the recipient can be sure that the data is in the form that the searcher saved it.

The present invention can also provide a mechanism for rendering the inquiry result corrupt if an editing attempt is detected or even if an attempt to read the data is detected. The corruption can be either physical corruption of the medium or informational corruption, such as scrambling or deletion of the stored inquiry result data.

The present invention, however, is not limited to smartcards or any particular type of data protection mechanisms. Objects of the invention are met when data is stored on any medium that allows a recipient to view the data while having confidence that no editing of the data has occurred.

Examples of relevant background data include, but are not limited to:
Criminal and incarceration records;
Citizenship, immigration, or legal working status;
Litigation records;
Driving and vehicle records;
Drug tests;
Education records;
Employment records;
Financial information;
Licensing records;
Medical, Mental, and Physiological evaluation and records;
Military records;
Confirmation of Social Security Number; and
Other interpersonal interviews (previous past employment to verify position and salary information. More intensive checks can involve interviews with anybody that knew or previously knew the applicant—such as teachers, friends, coworkers, and family members; however, extensive heresay investigations in background checks can expose companies to lawsuits.)

In addition, some embodiments of the present invention allow the recipient of the background check to update the information or to increase the scope of the search to, for instance, more areas of search or further back in time. This expansion of the search can be performed, for instance, by the recipient using an identifier previously provided by the data provider, to validate the recipient's authorization to view the data and/or additional data.

In still another embodiment, the subject can provide additional information to the searching entity for provision on the card. This step may be appropriate for non-verifiable information. For instance, the subject's resume can be included or awards or certificates that would not be locatable by a typical background search.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The terms “program”, “computer program”, “software application”, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

What is claimed is:

1. A method for providing secure personal information, the method comprising:
receiving a request for personal information pertaining to a subject's background;
conducting a personal information inquiry pertaining to the subject;
deriving a personal information inquiry result;
storing at least a portion of the inquiry result on a tangible medium, the inquiry result readable by a third party; and
protecting the inquiry result with at least one mechanism for preventing unauthorized editing by the subject.

2. The method according to claim 1, further comprising:
providing custody of the tangible medium to the subject.

3. The method according to claim 1, wherein the at least one mechanism comprises:
rendering the inquiry result corrupt in an event of editing by the subject.

4. The method according to claim 1, wherein the at least one mechanism comprises:
rendering the inquiry result corrupt in an event of inquiry result access by the subject.

5. The method according to claim 4, wherein:
the corrupt inquiry result is one of:
physical corruption of the tangible medium; and
informational corruption of the stored inquiry result.

6. The method according to claim 1, further comprising:
providing to a third party a means for accessing the inquiry result on the tangible medium.

7. The method according to claim 6, wherein:
the third party is a potential employer of the subject.

8. The method according to claim 1, wherein:
the tangible medium is a smart card.

9. The method according to claim 1, wherein:
the stored inquiry result is encrypted.

10. The method according to claim 1, further comprising:
providing an inquiry-result verification to the third party.

11. The method according to claim 1, wherein:
the stored inquiry result is valid only for a finite amount of time.

12. The method according to claim 1, wherein:
the storing is electronic.

13. A method for providing background information to a requesting party, the method comprising:
receiving, by a subject, a request for background information from a requesting party;
requesting performance of a background information inquiry from a searching party;
receiving from the searching party a tangible medium electronically storing a background information inquiry result and having at least one mechanism for preventing at least one of editing, copying, and replacement of the background information inquiry result by the subject; and
presenting the tangible medium to the requesting party.

14. The method according to claim 13, wherein the at least one mechanism comprises:
preventing access to the background information by the subject.

15. The method according to claim 13, further comprising:
presenting the tangible medium to at least one additional party as evidence of the subject's background history.

16. A method for receiving background information, the method comprising:
receiving a request for placement of a subject in a position of trust;
requesting from the subject information pertaining to the subject's background; and
receiving from the subject a tangible medium having at least one piece of background information pertaining to the subject stored thereon and having at least one mechanism for preventing editing, copying, and replacement of the background information by the subject.

17. The method according to claim 16, wherein the at least one mechanism comprises:
preventing access to the at least one piece of background information by the subject.

18. The method according to claim 16, further comprising:
placing the tangible medium in contact with a proprietary tangible medium reading machine.

19. The method according to claim 16, wherein:
the tangible medium is substantially a size and shape of a credit card.

20. The method according to claim 16, further comprising:
confirming a validity of the at least one piece of background information.

21. The method according to claim 16 further comprising:
confirming a non-expiration of the at least one piece of background information.
